(19) United States
(12) Patent Application Publication
(10) Pub. No.: US 2004/0198859 A1
(43) Pub. Date: Oct. 7, 2004

(54) Photopolymerization systems and their use

(76) Inventors: Chau K. Nguyen, Hattiesburg, MS (US); Charles E. Hoyle, Hattiesburg, MS (US)

Correspondence Address: EDGAR SPIELMAN, ALBEMARLE CORPORATION, 451 FLORIDA BLVD., BATON ROUGE, LA, 70801, US

(21) Appl. No.: 10/407,781

(22) Filed: Apr. 3, 2003

(51) Int. Cl. C08J 3/28

(52) U.S. Cl. 522/26

(57) ABSTRACT

Coinitiator systems for photopolymerization of photopolymerizable compounds containing olefinic unsaturation are described. Such systems comprise (A) either a combination of at least one coumarin photoinitiator and at least one coinitiator compound which is a hydrogen atom donating coinitiator or an electron donating coinitiator, or at least one coumarin photoinitiator having in its molecular structure at least one photosensitizing amino group; and (B) at least one compound containing at least one maleimide or maleic anhydride derivative. Photopolymerizable compositions which comprise, in addition to such a coinitiator system, at least one photopolymerizable compound containing olefinic unsaturation are also described.

### TECHNICAL FIELD

This invention relates to new photopolymerization systems capable of absorbing radiation from various excitation sources including UV radiation and visible light. The invention also relates to photopolymerization of one or more polymerizable compounds (monomers or oligomers) containing olefinic unsaturation using such systems.

### BACKGROUND

Ethylenically unsaturated compounds, such as acrylate derivatives, can be polymerized by exposure to radiation, typically ultraviolet light, in the presence of a photoinitiating system. Typically, the photoinitiating system includes (1) a compound capable of initiating polymerization of the ethylenically unsaturated compound upon exposure to radiation (a “photoinitiator”) and optionally (2) a coinitiator or synergist, that is, a molecule which serves as a hydrogen atom donor. The coinitiators or synergists are typically alcohols, tertiary amines, amides, or ethers which have labile hydrogens attached to a carbon adjacent to a heteroatom. Commercially available photoinitiators include benzophenones and derivatives thereof, such as thioxanthone derivatives.

Maleimides, and in particular N-aliphatic and ortho-substituted (i.e., “twisted”) N-aromatic maleimides have been investigated as comonomer photoinitiators of UV-curable acrylic systems. These maleimides have been observed to require the presence of a hydrogen atom-donor synergist (such as an amine, ether, thiol, or the like) to obtain reasonable rates of initiation and polymerization.

Three component photoinitiation systems composed of an iodonium salt, an electron donor (often an amine), and a light absorbing component (typically a dye), and have been been found effective. See for example Kawabata et al., J. Photopolm. Sci. Tech., 1988, 1, 222, He et al., Chin. J. Polym. Sci., 1990, 8, 44; Oxman et al. U.S. Pat. No. 4,735,632. A variety of light absorbing components have been proposed or used in such systems including coumarins and ketocoumarins. See for example Kawabata et al., ibid.; Oxman et al., ibid.; Fouassier et al., J. Polym. Sci. A: Polym. Chem., 1993, 31, 2245; Kawabata et al., U.S. Pat. No. 4,868,092; Fouassier et al., J. Appl. Polm. Sci., 1992, 44, 1779; Ito, JP 3-70704 (Published 1991).

While attempts have been made to replace the iodonium salt in three component photoinitiator systems by another component, only a few cases have proven to be successful. Apparently the reason for this is that the precise role played by the iodonium salt was not well understood. Reported efforts along these lines are replacement of the iodonium salt by a bromine compound such as 2,2,2-tribromoacetophenone or by an ferrometallocene salt. In addition, WO 99/39247, published in 1999, describes three component photoinitiation systems in which a benzophenone compound or a thioxanthrone compound is used in a system comprised of a maleimide and a hydrogen atom donor or electron donor.

Additional new, effective three component photoinitiation systems would constitute advantageous contributions to the art, especially if such systems could make it possible to use visible light sources in photopolymerization operations conducted at higher speeds than are typically achieved using conventional two component systems. It would be additionally advantageous if this could be accomplished using initiator systems that can be used with a variety of actinic light sources.

This invention is deemed to enable the achievement of one or both of such advantageous features.

### BRIEF SUMMARY OF THE INVENTION

In one of its embodiments, this invention provides novel coinitiator systems useful in effecting photopolymerization of one or more photopolymerizable compounds containing olefinic unsaturation. These systems comprise:

a) (i) a combination of at least one coumarin photoinitiator and at least one coinitiating compound which is a hydrogen atom donating coinitiator or an electron donating coinitiator, or (ii) at least one coumarin photoinitiator having in its molecular structure at least one photosensitizing amino group; and

b) at least one compound containing at least one maleimide or maleic anhydride moiety.

It will be seen that if the coumarin contains in its own molecular structure a photosensitizing amino group, the system can be composed of but two different types of molecular components, viz., one or more coumarin photoinitiators having in the molecular structure at least one photosensitizing amino group, and one or more compounds containing at least one maleimide or maleic anhydride moiety. Preferred systems of this invention are three component systems composed of (1) at least one coumarin photoinitiator, (2) at least one hydrogen atom or electron donating coinitiator, and (3) at least one compound containing at least one maleimide or maleic anhydride moiety.

This invention is also directed to photopolymerizable compositions and methods for radiation curing of the same. The photopolymerizable compositions of the invention include at least one radiation curable compound, preferably an olefinically unsaturated curable compound, i.e., at least one ethylenically unsaturated compound, and preferably, one or more acrylate derivatives. The compositions further include the above-specified component(s) of a) and the maleic component(s) of b) above. The components of a) and b) working together have the capability of initiating the photopolymerization of the radiation curable compound more rapidly or efficiently than the corresponding amount of component a) alone.

Another embodiment of this invention is a process which comprises photopolymerizing one or more polymerizable compounds containing olefinic unsaturation by exposing such compound or compounds to radiation in the presence of a polymerization coinitiator composition comprised of the above-specified component(s) of a) and the maleic component(s) of b) above. The selected coinitiator system is proportioned to initiate the photopolymerization of the radiation curable compound more rapidly or efficiently than the corresponding amount of component a) alone.

A substantial rate enhancing effect has been found to occur when a suitably active coumarin sensitizer is used in conjunction with a maleic component in the presence of a hydrogen atom donor in the photopolymerization of typical acrylic photocurable systems, as compared to rates obtained when using the same acrylic photo-curable system with the coumarin sensitizer with a hydrogen-atom donor as the initiating system.

These and other embodiments and features of this invention will be still further apparent from the ensuing description, accompanying drawings, and appended claims.

### BRIEF DESCRIPTION OF THE DRAWINGS

FIG. 1 is a plot of photo-differential scanning calorimetry (DSC) exotherms depicting the performance under radiation at 365 nm of a coinitiator system of this invention as compared to the same initiator system in the absence of a maleic component in photopolymerization of 1,6-hexanedioldiacrylate (HDDA), and also as compared to a conventional type I cleavage photoinitiator, DMPA.

FIG. 2 is a graphical depiction of the peak photo-(DSC) exotherms in photopolymerization of HDDA with the same coinitiator system of this invention as used in FIG. 1, but in which the weight percentages of the maleic component were varied from 0 up to 1%.

FIG. 3 is a graphical depiction of the peak photo-(DSC) exotherms in photopolymerization of HDDA with the same coinitiator system of this invention as used in FIG. 1, but in which the weight percentages of the amine component were varied from 0.5% up to 2%.

FIG. 4 is a plot of photo-differential scanning calorimetry (DSC) exotherms depicting the performance under radiation at 365 nm of another coinitiator system of this invention as compared to the same initiator system in the absence of a maleic component in photopolymerization of 1,6-hexanedioldiacrylate (HDDA), and also as compared to a conventional type I cleavage photoinitiator, DMPA.

FIG. 5 is a graphical depiction of the peak photo-(DSC) exotherms in photopolymerization of HDDA with the same coinitiator system of this invention as used in FIG. 4, but in which the weight percentages of the maleic component were varied from 0 up to 1%.

FIG. 6 is a graphical depiction of the peak photo-(DSC) exotherms in photopolymerization of HDDA with the same coinitiator system of this invention as used in FIG. 4, but in which the weight percentages of the amine component were varied from 0.5% up to 2%.

FIG. 7 is a plot of photo-differential scanning calorimetry (DSC) exotherms depicting the performance under radiation at 365 nm of still another coinitiator system of this invention as compared to the same initiator system in the absence of a maleic component in photopolymerization of 1,6-hexanedioldiacrylate (HDDA), and also as compared to a conventional type I cleavage photoinitiator, DMPA.

FIG. 8 is a graphical depiction of the peak photo-(DSC) exotherms in photopolymerization of HDDA with the same coinitiator system of this invention as used in FIG. 7, but in which the weight percentages of the maleic component were varied from 0 up to 1%.

FIG. 9 is a graphical depiction of the peak photo-(DSC) exotherms in photopolymerization of HDDA with the same coinitiator system of this invention as used in FIG. 7, but in which the weight percentages of the amine component were varied from 0.5% up to 2%.

FIG. 10 is a plot of photo-differential scanning calorimetry (DSC) exotherms depicting the performance under radiation at 436 nm of yet another coinitiator system of this invention as compared to the same initiator system in the absence of a maleic component in photopolymerization of 1,6-hexanedioldiacrylate (HDDA), and also as compared to a conventional type I cleavage photoinitiator, DMPA, under radiation at 365 nm.

FIG. 11 is a graphical depiction of the peak photo-(DSC) exotherms in photopolymerization of HDDA with the same coinitiator system of this invention as used in FIG. 10, but in which the weight percentages of the maleic component were varied from 0 up to 1%.

FIG. 12 is a graphical depiction of the peak photo-(DSC) exotherms in photopolymerization of HDDA with the same coinitiator system of this invention as used in FIG. 10, but in which the weight percentages of the amine component were varied from 0.5% up to 2%.

FIG. 13 depicts one possible mechanism for the enhanced sensitization achieved using for illustrative purposes one of the preferred coinitiator system of this invention.

### FURTHER DETAILED DESCRIPTION OF THE INVENTION

Coumarin Components

The coumarins used in the practice of this invention are those whose polymerization rate under a given radiation is increased by a hydrogen atom donating coinitiator or an electron donating coinitiator and which rate is still further enhanced by the presence of the maleic component. Without being bound by theory, it is believed that a suitable coumarin compound is one in which its triplet state has sufficient energy to sensitize the maleic component. Also, it is theorized that the coumarin should be capable of yielding a ketyl radical which in turn is capable of donating an electron to the maleic component.

Component a) can be either (i) a combination of at least one coumarin photoinitiator and at least one coinitiator compound which is a hydrogen atom donating coinitiator or an electron donating coinitiator, or (ii) at least one coumarin photoinitiator having in its molecular structure at least one photosensitizing amino group. In the latter case (ii) the additional presence of a separate compound serving as a hydrogen atom donating coinitiator or an electron donating coinitiator is optional. Also, in either the former case (i) or latter case (ii), the hydrogen atom donor can be included as a molecular component of the photopolymerizable compound or mixture of compounds to be photopolymerized pursuant to this invention.

Coumarin photoinitiators of the first type that are used in combination with at least one coinitiator compound which is a hydrogen atom donating coinitiator or an electron donating coinitiator can be of various molecular structures. One category of such coumarins is one or a mixture of 3-substituted coumarins having an absorptive maximum between about 250 and 550 nm. Among suitable coumarins are 3-substituted coumarins which have in the 3-position a substituted carbonyl, substituted sulfonyl, substituted sulfinyl, substituted oxycarbonyl, carboxyl or cyano group.

Such coumarins can also be described as having the formula:

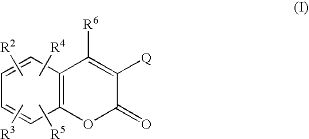

wherein Q is —CN, carboxyl, ammonium or alkali metal salts of carboxyl, or -ZR¹; Z is a linking group selected from carbonyl, sulfonyl, sulfinyl or arylenedicarbonyl; R¹ is hydroxy, a hydrocarbyl group which has up to about 12 carbon atoms and is devoid of acetylenic unsaturation, a hydrocarbyloxy group which has up to about 12 carbon atoms and is devoid of acetylenic unsaturation, a heterocyclic group having about 5-15 nuclear carbon and hetero atoms, with or without substituents such as 3-pyridyl, 4-pyridyl, furyl, 2-benzofuranyl, 2-thiazolyl, 2-thienyl, pyridinium having the formula:

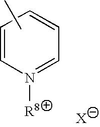

in which R⁸ is alkyl having 1-4 carbon atoms including methyl, ethyl, propyl, isopropyl, butyl, n-butyl, isobutyl, sec-butyl, etc., and X^{⊖} is an anion including FSO₃^{⊖}, BF₄^{⊖}, toluene sulfonate, halogen, e.g., Cl, Br, I, etc.; or a 3-coumarinyl group having the formula:

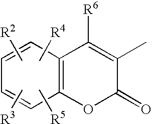

and wherein R², R³, R⁴ and R⁵ are each independently hydrogen; hydroxy, alkoxy having 1-6 carbon atoms, such as methoxy, ethoxy, n-propoxy, iso-propoxy, n-butoxy, pentoxy, and the like; acyloxy, e.g., acetoxy, benzoyloxy and the like; alkoxycarbonyl of 2-6 carbon atoms, e.g., methoxycarbonyl, ethoxycarbonyl and the like; dialkylamino with each alkyl containing 1 to 4 carbon atoms, for example dimethylamino, diethylamino and the like; halogen, for example, chloro, bromo, iodo, and the like; nitro; a 5- or 6-membered heterocyclic group, for example pyrrolidino, morpholino, piperidino, pyridinium, and the like; a halo-substituted alkoxy group, for example β-chloroethoxy, β-iodoethoxy and the like; or a group having the structure:

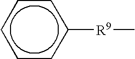

where R⁹ is an alkylene having 1-5 carbon atoms, e.g., methylene, ethylene, etc.; and R⁶ is hydrogen; alkyl of 1-4 carbon atoms, for example, methyl, ethyl, propyl, isopropyl, and the like; aryl of 6-10 carbon atoms, for example, phenyl, naphthyl and the like; or acyl, for example, acetyl, benzoyl and the like. Some examples or substituents for the substituted alkoxy of R²-R⁵, which do not destroy the sensitizing effect, include for example, halogens such as chloro, iodo, and the like; sulfo salts; ammonio salts, for example, trimethylammonio salt and the like; hydroxy; acyl, for example acetyl, benzoyl, and the like; and aryl, for example, phenyl, naphthyl, and the like.

Typical coumarins of Formula (I) which can be used include, for example:

3-benzoyl-5,7-dimethoxycoumarin

3-benzoyl-7-methoxycoumarin

3-benzoyl-6-methoxycoumarin

3-benzoyl-8-ethoxycoumarin

7-methoxy-3-(p-nitrobenzoyl)coumarin

3-benzoylcoumarin

3-(p-nitrobenzoyl)coumarin

3-benzoylbenzo[f]coumarin

3,3′-carbonylbis(7-methoxycoumarin)

3-acetyl-7-methoxycoumarin

3-benzoyl-6-bromocoumarin

3,3′-carbonylbiscoumarin

3-benzoyl-7-methylaminocoumarin

3,3′-carbonylbis(7-diethylaminocoumarin)

3-carboxycoumarin

3-carboxy-7-methoxycoumarin

3-methoxycarbonyl-6-methoxycoumarin

3-ethoxycarbonyl-6-methoxycoumarin

3-ethoxycarbonyl-7-methoxycoumarin

3-methoxycarbonyl-7-methoxycoumarin

3-acetylbenzo[f]coumarin

3-acetyl-7-methoxycoumarin

3-(1-admantoyl)-7-methoxycoumarin

3-benzoyl-7-hydroxycoumarin

3-benzoyl-6-nitrocoumarin

3-benzoyl-7-acetoxycoumarin

3-[3-(p-ethoxyphenyl)acryloyl]-7-methoxycoumarin

3-benzoyl-7-diethylaminocoumarin

7-dimethylamino-3-(4-iodobenzoyl)coumarin

7-diethylamino-3-(4-iodobenzoyl)coumarin

3,3′-carbonylbis(5,7-diethoxycoumarin)

3-(2-benzofuroyl)-7-(1-pyrrolidinyl)coumarin

7-diethylamino-3-(4-dimethylaminobenzoyl)coumarin

7-methoxy-3-(4-methoxybenzoyl)coumarin

3-(4-nitrobenzoyl)benzo [f] coumarin

3-(4-ethoxycinnamoyl)-7-methoxycoumarin

3-(4-dimethylaminocinnamoyl)coumarin

3-(4-diphenylaminocinnamoyl)coumarin

3-[(3-methylbenzothiazol-2-ylidene)acetyl]coumarin

3-[(1-methylnaphtho[1,2-d]thiazol-2-ylidene)acetyl]coumarin

3,3′-carbonylbis(6-methoxycoumarin)

3,3′-carbonylbis(7-acetoxycoumarin)

3,3′-carbonylbis(7-dimethylaminocoumarin)

3,3′-carbonylbis(5,7-di-isopropoxycoumarin)

3,3′-carbonylbis(5,7-di-n-propoxycoumarin)

3,3′-carbonylbis(5,7-di-n-butoxycoumarin)

3,3′-carbonylbis[5,7-di(2-phenylethoxy)coumarin]

3,3′-carbonylbis[5,7-di(2-chloroethoxy)coumarin]

3-cyano-6-methoxycoumarin

3-cyano-7-methoxycoumarin

7-methoxy-3-phenylsulfonylcoumarin

7-methoxy-3-phenylsulfinylcoumarin

1,4-bis(7-diethylamino-3-coumarylcarbonyl)benzene

7-diethylamino-5′,7′-dimethoxy-3,3′-carbonylbiscoumarin

7-dimethylamino-3-thenoyl coumarin

7-diethylamino-3-furoyl coumarin

7-diethylamino-3-thenoyl coumarin

3-benzoyl-7-(1-pyrrolidinyl)coumarin

3-(4-fluorosulfonyl)benzoyl-7-methoxycoumarin

3-(3-fluorosulfonyl)benzoyl-7-methoxycoumarin

5,7-dimethoxy-3-(1-naphthoyl)coumarin

5,7,6′-trimethoxy-3,3′-carbonylbiscoumarin

5,7,7′-trimethoxy-3,3′-carbonylbiscoumarin

7-diethylamino-6′-methoxy-3,3′-carbonylbiscoumarin

3-nicotinoyl-7-methoxycoumarin

3-(2-benzofuroyl)-7-methoxycoumarin

3-(7-methoxy-3-coumarinoyl)-1-methylpyridinium fluorosulfate

3-(5,7-diethoxy-3-coumarinoyl)-1-methylpyridinium fluoroborate

N-(7-methoxy-3-coumarinoylmethyl)pyridinium bromide

3-(2-benzofuroyl)-7-diethylaminocoumarin

7-(1-pyrrolidinyl)-3-thenoylcoumarin

7-methoxy-3-(4-pyridinoyl)coumarin

3,6-dibenzoylcoumarin

N-(7-methoxy-3-coumarinoylmethyl)-N-phenylacetamide and

9-(7-diethylamino-3-coumarinoyl)-1,2,4,5-tetrahydro-3H,6H,10H[1]benzopyrano[9,9a,1-gh]quinolazine-10-one.

Preferred coumarins have the following formula:

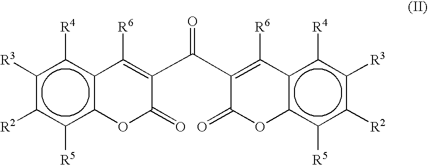

wherein each R² is alkoxy having 1 to 6 carbon atoms or dialkylamino with each alkyl containing 1 to 4 carbon atoms, and R³, R⁴, R⁵, and R⁶ are, independently, hydrogen atoms or alkyl groups each containing 1 to 6 carbon atoms and wherein at least two pairs of R³, R⁴, R⁵, and R⁶ are all hydrogen atoms. Of these compounds more preferred are those in which each R² is dialkylamino with each alkyl containing 1 to 4 carbon atoms and at least three pairs of R³, R⁴, R⁵, and R⁶ are all hydrogen atoms. Particularly preferred coumarins of Formula (II) are those in which R² is dialkylamino with each alkyl containing 1 to 4 carbon atoms and all of R³, R⁴, R⁵, and R⁶ are hydrogen atoms.

Another group of coumarins which can be used in the practice of this invention are those having the formula:

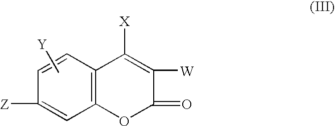

wherein X and Y are each hydrogen, lower alkyl or lower alkoxy;

Z is hydrogen, lower alkyl, lower alkoxy or dilower alkylamino;

W is hydrogen, lower alkyl, phenyl containing a lower alkoxy group in the o- or p-position, and phenyl containing a substituted amino group in the o- or p-position; and wherein at least one of W and Z is other than hydrogen or lower alkyl. Stated differently, the coumarin must contain at least one of the dialkylamino, alkoxy, alkoxyphenyl or aminophenyl groups in the 3- or 7-position. These coumarins absorb maximally in the 300-400 nm region, particularly in the 340-390 nm region.

A subclass of coumarins of Formula (III) useful in the practice of this invention comprises 7-diloweralkylamino-4-lower alkyl coumarins. These coumarins include such compounds as 7-dimethylamino-4-ethyl coumarin, 7-dibutylamino-4-butyl coumarin, 7-diethylamino-4-ethyl coumarin, 7-dibutylamino-4-methyl coumarin, and 7-dimethylamino-4-methyl coumarin (λ max. 360 nm in EtOH, ε=20,700) and 7-diethylamino-4-methyl coumarin (λ max. 375 nm in EtOH, ε=22,000).

Another subclass of coumarins of Formula (III) are the 7-lower alkoxycoumarins such as 7-methoxycoumarin, 7-ethoxycoumarin, 7-propoxycoumarin, 7-butoxycoumarin, 5,7-dimethoxycoumarin. Still another subclass includes the 3-(ortho- or para-alkoxyphenyl)coumarins such as 3-(p-methoxyphenyl)coumarin, 3-(o-methoxyphenyl)coumarin, 3-(p-ethoxyphenyl)-7-methylcoumarin, 3-(p-butoxyphenyl)coumarin, 3-(p-methoxy-5-methylcoumarin), and 3-(o-, p-dimethoxyphenylcoumarin. Still another substituted coumarin of this type has the formula:

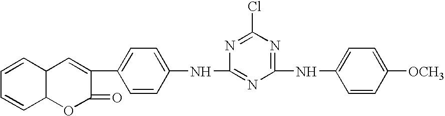

Methods for the preparation of coumarins are known and reported in the literature. See for example, Chemical Reviews, 1945, 361, S. M. Sethna and N. H. Shah, R. K. Pandya and K. C. Pandya, Agr. Univ. J. Research, 1955, 4, 345, Chem. Abstr., 52, 7307b. Bis compounds are described in L. L. Woods and M. Fooladi, J. Chem. Eng. Data, 1967, 12, 624. See also the following documents:

U.S. Pat. No. 3,533,797 issued Oct. 13, 1970, which includes a description of coumarin photosensitizers having at least one dialkylamino, alkoxy, alkoxyphenyl, or aminophenyl group in the 3- or 7-position, and that absorb maximally in the 300-400 nm region.

U.S. Pat. No. 3,756,827 issued Sep. 4, 1973 (reissued Apr. 27, 1976 as Re. 28,789), which describes photopolymerizable compositions comprising, among other things, a 7-(diloweralkylamino)-4-loweralkyl coumarin and optionally an amine hydrogen donor, together with a cyclic cis-α-dicarbonyl compound.

U.S. Pat. No. 4,147,552, issued Apr. 3, 1979, and Brit. 1 578 662 published Nov. 5, 1980, which describe the use of 3-substituted coumarin compounds as spectral sensitizers for photopolymerization.

E.P. 0 022 188 A2, published Jan. 14, 1981, which describes coinitiator systems for photopolymerization composed of a 3-keto-substituted coumarin sensitizer with a maximum absorption of radiation between 250 and 550 nm, and an amine coinitiator, which can be, inter alia, an amino-derivative of acetic acid.

U.S. Pat. No. 4,247,623, issued Jan. 27, 1981, which refers to use of photoinitiator mixtures composed of a 3-ketocoumarin and an amine in formation of frames of metal beam leads that are bonded to integrated circuit chips.

U.S. Pat. No. 4,250,053, issued Feb. 10, 1981, which describes photoinitiator systems composed of an aromatic iodonium or sulfonium salt and a sensitizer which can be a coumarin.

U.S. Pat. No. 4,278,751, issued Jul. 14, 1981, which describes as photopolymerization coinitiators, combinations of a visible light-responsive amine-substituted ketocoumarin having an absorption maximum between about 350 and about 550 nm and a specified type of amine activator.

U.S. Pat. No. 4,289,844, issued Sep. 15, 1981, and 4,366,228, issued Dec. 28, 1982, which describe as photopolymerization coinitiators, combinations of a 3-ketocoumarin and an activator which can be, inter alia, an amine other than a 3-ketocoumarin amine.

U.K. Patent Application GB 2 083 832 A published Mar. 31, 1982, which describes photopolymerization initiator compositions composed, of an amino-substituted photosensitizer such as an amino-substituted 3-ketocoumarin and a specified N-heterocyclic compound as an activator.

U.S. Pat. No. 4,505,793, issued Mar. 19, 1985, which describes photopolymerizable compositions having as the initiator a combination of a 3-keto-substituted coumarin and an active halogeno compound such as a trichloromethyl substituted triazine having an amino substituent.

U.S. Pat. No. 4,713,312, issued Dec. 15, 1987, which describes use in microcapsules of a 3-substituted coumarin compound which can be amino substituted, and that is sensitive in the 390-500 nm portion of the spectrum.

U.S. Pat. No. 4,992,547, issued Feb. 12, 1991, which describes as a photopolymerizable system the combination of certain aryl secondary alkyl ketones which are substituted in the alpha position by an oxygen or amine function and a photosensitizer which can be a coumarin.

Coumarin photoinitiators of the second type, i.e., those which do not require use of a separate hydrogen atom donating coinitiator compound or a separate electron donating coinitiator typically are those that contain a suitably disposed or tethered tertiary amine in their molecular structure. One group of suitable coumarins of this type can be depicted by the formula

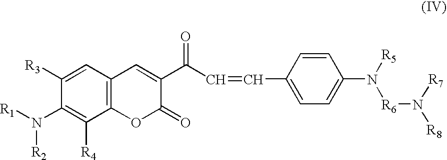

wherein R₁ and R₂ each represent an alkyl group having 1 to 6 carbon atoms, and R₃ and R₄ each represent hydrogen; or at least one of R₁ and R₃ or R₂ and R₄ together represent an alkylene group having 2 to 4 carbon atoms,

R₅ represents an alkyl group having 1 to 6 carbon atoms or H,

R₆ represents an alkylene group having 1 to 6 carbon atoms,

R₇ and R₈ each independently represent an alkyl group having 1 to 6 carbon atoms, both of R₇ and R₈ taken together represent an alkylene group having 4 to 6 carbon atoms, or R₅ or R₆ taken together with R₇ or R₈ represent a five, six, or seven membered heterocyclic ring group. R₇ and R₈ preferably together represent an alkylene group of 4 to 6 carbon atoms forming a cyclic group with the N atom to which they are attached.

For further details concerning coumarins of Formula (IV), one may refer to Ali, U.S. Pat. No. 5,415,976, issued May 16, 1995, which describes aminoketone-substituted coumarin sensitizers having tethered tertiary amino groups used with iodonium and triazine photo initiators.

Hydrogen Atom or Electron Donating Coinitiator Compound

Suitable components of this type, sometimes referred to in the art as activators, accelerators, coinitiators, or cosynergists vary widely in chemical composition. They include amines, thiols, ethers, alcohols, amides, ureas, and the like. Of these classes of coinitiators, amines, thiols, ethers, and alcohols having at least one available hydrogen atom attached to a carbon atom adjacent to a hetero atom are preferred, with amines of this type being most preferred as a class. Numerous amines, such as those described in U.S. Pat. No. 3,759,807 from Column 5, line 3 to Column 6, line 6, constitute candidate compounds for use, but for best results the amine should have at least one available hydrogen atom attached to a carbon atom adjacent to a hetero atom. More preferred amines are one or a mixture of trihydrocarbylamines or one or a mixture of tertiary alkanolamines having “n” alkanol groups and “3−n” hydrocarbyl groups in the molecule, where n is 1 to 3 or a mixture of at least one trihydrocarbylamine and at least one such tertiary alkanolamine, and wherein at least one available hydrogen atom is attached to a carbon atom adjacent to a hetero atom of such trihydrocarbylamine(s) or tertiary alkanolamine(s). A few non-limiting examples of such amines are triethanolamine, N-methyl-N,N-diethanolamine, N-ethyl-N,N-diethanolamine, and esters of dimethylaminobenzoic acid.

The suitability of any given hydrogen atom or electron donating coinitiator if not already known, can be determined by carrying out a photo-differential scanning calorimetry determination using the candidate compound in combination with the selected coumarin and 1,6-hexanedioldiacrylate under the selected radiation source and comparing the exotherm so produced with the exotherm produced by the corresponding composition under the same conditions but devoid of the candidate compound. If the candidate compound increases the photo-differential scanning calorimetry exotherm, the candidate compound is suitable for use in the practice of this invention.

Maleic Compounds

These components can contain a maleimide functionality or a maleic anhydride functionality. A few non-limiting examples of such imides include maleimide, a 2-alkylmaleimide, a 2,3-dialkylmaleimide, an N-hydrocarbylmaleimide, an N-hydrocarbylmaleimide having an alkyl group in the 2-position or in both the 2- and 3-positions, a 2-alkenyl maleimide, an N-hydrocarbylmaleimide having an alkenyl group in the 2-position, a functionalized aliphatic maleimide, an aromatic maleimide, an oligomeric maleimide, a bridged maleimide, or the like. A mixture of any two or more of these can be used. A few non-limiting examples of the anhydrides include maleic anhydride, a 2-alkylmaleic anhydride, a 2,3-dialkylmaleic anhydride, a 2-alkenylmaleic anhydride, a bridged maleic anhydride, a functionalized aliphatic maleic anhydride, an aromatic maleic anhydride, an oligomeric maleic anhydride, or the like. A mixture of any two or more of these can be used. Mixtures of one or more such maleic imides with one or more such maleic anhydrides can also be used. The maleic imide or anhydride component can be substantially completely consumed during initiation and photopolymerization (incorporated into the polymer structure).

Thus, maleic components useful in the compositions of the invention include maleimides of the formula

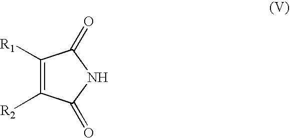

and maleic anhydrides of the formula

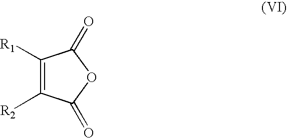

wherein:

each R, and R₂ is independently selected from the group consisting of 10 hydrogen, C1 to C10 alkyl, cycloalkyl, aryl, alkoxy, and halogen, or R₁ and R₂ together form a fused saturated or unsaturated five or six membered cyclic hydrocarbon or heterocyclic ring system containing one or two O, N or S atoms, optionally substituted with alkyl, aryl, halogen, arylalkyl, alkylaryl, cycloalkyl, alkoxy, heteroatoms, silicon, and the like. Such compounds are commercially available and/or can be prepared using commercially available starting materials using techniques known in the art.

Alkyl maleimides useful in the invention include compounds having at least one maleimide functional group substituted with a linear, branched or cyclic C₁-C₁₀ alkyl substituent at the nitrogen atom. Exemplary alkyl maleimide compounds can have the formula below:

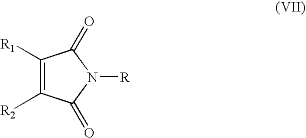

wherein:

each R₁ and R₂ is independently selected from the group consisting of hydrogen, C1 to C10 alkyl, cycloalkyl, aryl, alkoxy, and halogen, or R₁ and R₂ together form a fused saturated or unsaturated five or six membered cyclic hydrocarbon or heterocyclic ring system containing one or two O, N or S atoms, optionally substituted with alkyl, aryl, halogen, arylalkyl, alkylaryl, cycloalkyl, alkoxy, heteroatoms, silicon, and the like; and

R is straight chain, branched or cyclic C1-C10 alkyl, optionally substituted with one or more C1-C4 alkyl, and preferably is C1-C4 alkyl or C6 cycloalkyl.

Exemplary alkyl maleimides include without limitation methyl maleimide, hexyl maleimide, cyclohexyl maleimide, and the like. Such compounds are known in the art and can be prepared using techniques known in the art. See, for example, Z. Y. Wang, Synthetic Comm. 20(11)1607-1610 (1990); P. O. Tawney et al., J. Org. Chem. 26, 15(1961); and U.S. Pat. No. 2,542,145. Aliphatic maleimide compounds useful in the invention include compounds having at least one maleimide unit substituted with a functionalized aliphatic substituent at the nitrogen atom. The aliphatic substituent preferably is a linear or branched C₁ to C₁₀ alkyl, and more preferably methyl or ethyl. The alkyl is optionally substituted with C₁ to C₄ alkyl, C₁ to C₄ alkoxy, halogen, and the like as described below.

Aliphatic maleimides useful in the invention can be monofunctional (have one maleimide functional group), or can be di- or multi-functional (have two or more maleimide functional groups). For example, two or more aliphatic maleimide units can be connected or coupled via a spacer group(s), such as, but not limited to, linear or branched C₁ to C₁₀ alkyl, C₃ to C₆ cycloalkyl optionally substituted with C₁ to C₄ alkyl, C₁ to C₁₀ oxyalkyl, which can include one or more oxygen atoms, such as that derived from ethylene glycol, carbonate, aryl, alkylaryl, arylalkyl, and the like. Still further, maleimide compounds useful in the invention include maleimide units connected to polymeric or oligomeric compounds (typically having a molecular weight of at least 1000). For example, unsaturated polyester resins with varying percent maleimide functionality incorporated therein as known in the art can be used.

Exemplary aliphatic maleimide compounds can have the formula below:

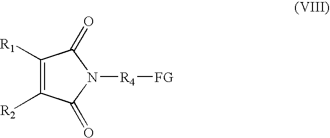

wherein:

(a) each R₁ and R₂ is independently selected from the group consisting of hydrogen, C₁ to C₁₀ alkyl, cycloalkyl, aryl, alkoxy, and halogen, or R₁ and R₂ together form a fused saturated or unsaturated five or six membered cyclic hydrocarbon or heterocyclic ring system containing one or two O, N or S atoms, optionally substituted with alkyl, aryl, halogen, arylalkyl, alkylaryl, cycloalkyl, alkoxy, heteroatoms, silicon, and the like;

(b) R₄ is linear or branched C₁ to C₁₀ alkyl, heteroatom, or silicon —SiH₂—; and

(c1) when R₄ is C₁ to C₁₀ alkyl, FG is a functional group selected from the group consisting of —OR₃, —SR₃, —SiH₂R₃, —OC(O)N(R₃)₂, —OC(O)C(═CHR₃)R₃, —OC(O)R₃, —C(O)R₃, N(R₃)₂, —C(O)OR₃, —NCO, —C(O)N(R₃)₂, —OC(O)OR₃, —CN, halogen, —CH₂N-aryl-FG′, —CH₂N-aryl-R₃—FG′, sulfonic acid, quaternary ammonium, and salts thereof, in which each R₃ is selected from the group consisting of hydrogen, alkyl, aryl, cycloalkyl, arylalkyl, and alkylaryl, and in which FG′ is selected from the group consisting of —OR₃, —SR₃, —SiH₂R₃, —OC(O)N(R₃)₂, —OC(O)C(═CHR₃)R₃, —OC(O)R₃, —C(O)R₃, —N(R₃)₂, —C(O)OR₃, —NCO, —C(O)N(R₃)₂, —OC(O)OR₃, —CN, halogen, sulfonic acid, and quaternary ammonium, or

(c2) when R₄ is a heteroatom or silicon —SiH₂—, FG is selected from the group consisting of hydrogen, alkyl, axyl, cycloalkyl, allcylaryl, arylalkyl, alkyl-FG″, and aryl-FG″, wherein FG″ is the same as FG′ as defined in (c1) above, or

(c3) FG is a functional group as defined in (c1) in combination with a 5 spacer group linking said maleimide unit with at least one other maleimide unit to form a di- or multifunctional maleimide compound. Exemplary spacer groups include without limitation linear or branched C₁ to C₁₀ alkyl, C₃ to C₆ cycloalkyl, optionally substituted with lower C₁ to C₄ alkyl, C₁ to C₁₀ oxyaLkyl, which can include one or more oxygen atoms, such as that derived from ethylene glycol, carbonate, and the like. Aliphatic maleimides useful in the invention are described, for example, in pending U.S. application Ser. No. 08/917,024, filed Aug. 22, 1997, titled “Polymerization Processes Using Aliphatic Maleimides,” and its corresponding published international application PCT Publication No. WO 98/07759, the entire disclosure of each of which is hereby incorporated by reference.

Exemplary aliphatic maleimides useful in the invention include, but are not limited to:

hydroxy methylmaleimide (HMMI)

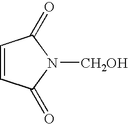

hydroxy ethylmaleimide (HEMI)

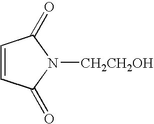

triethylene glycol biscarbonate bisethylmaleimide (TEGBCBEMI)

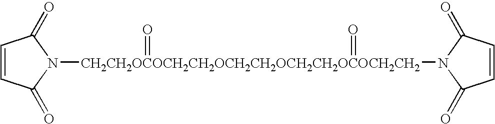

2-ethylcarbonate ethylmaleimide (2ECEMI)

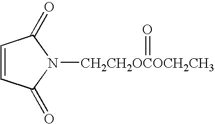

2-isopropyl urethane ethylmaleimide (2IPUEMI)

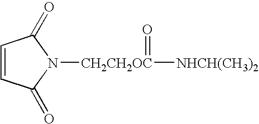

2-acryloyl ethylmaleimide (2AEMI)

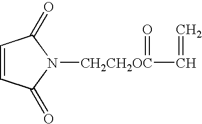

acetoxy ethyl maleimide (AcOEMI)

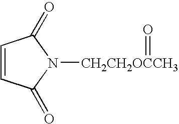

isophorone bisurethane bisethylmaleimide (IPBUBEMI)

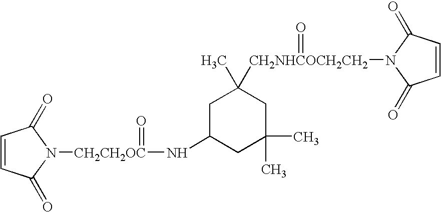

bisethylmaleimide carbonate (BEMIC)

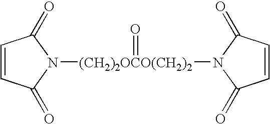

4,9-dioxa-1,12 dodecane bismaleimide (4,9-DO-1,12-DDBMI)

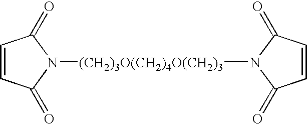

bispropyl maleimide (BPMI)

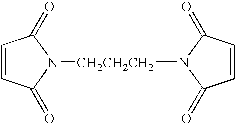

dodecane N,N′-bismaleimide

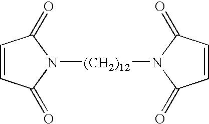

and the like.

Generally, aliphatic maleimides which include at least one maleimide unit as described above can be prepared using techniques known in the art. See, for example, Z. Y. Wang, Synthetic Conini. 20(11)1607-1610 (1990); P. O. Tawney et al., J. Org. Chem. 26, 15 (1961); and U.S. Pat. Nos. 2,542,145, 6,034,150, and 6,369,124. All disclosures of the foregoing references dealing with aliphatic maleimides or their synthesis are incorporated herein by reference as if fully set forth herein.

Aromatic maleimides useful in invention include compounds according to formula below:

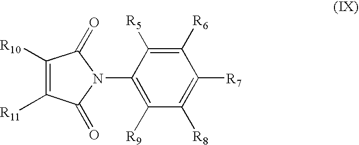

wherein:

each of R₅, R₆, R₇, R₈, and R₉, is independently selected from the group consisting of H, CX₃, COOR₁₂, COR₁₂, OR₁₂, CN, SR₁₂, N(Rn)₂, R₁₃, X, and MI, R₁₀ and R₁₁ each is independently selected from the group consisting 15 of H, C1 to C10 alkyl, preferably C1-C4 alkyl, more preferably CH₃, cycloalkyl, aryl, alkoxy, arid halogen, preferably chloride, or R₁ and R₂ together form a fused saturated or unsaturated five or six membered êyclic hydrocarbon or heterocyclic ring system containing one or two O, N or S atoms, optionally substituted with alkyl, aryl, halogen, arylalkyl, alkylaryl, cycloalkyl, alkoxy, heteroatoms, silicon, and the like; X is halide, preferably F, Cl, Br, or 1; R₁₂ is selected from the group consisting of H, lower alkyl, cycloalkyl, and aryl; R₁₃ is selected from the group consisting of lower alkyl, cycloalkyl, and aryl, or R₁₃ is a spacer group connecting at least two compounds of the above formula to form a di- or multi-functional maleimide; and MI is

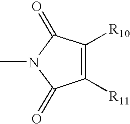

wherein R₁₀ and R₁₁ are as defined above. For example, two or more aromatic maleimide units can be connected or coupled via a spacer group(s), such as, but not limited to, linear or branched C1 to C10 alkyl, C₃ to C₆ cycloalkyl optionally substituted with C₁ to C₄ alkyl, C₁ to C₁₀ oxyalkyl, which can include one or more oxygen atoms, such as that derived from ethylene glycol, carbonate, aryl, alkylaryl, arylalkyl, and the like. The spacer group can be, for example:

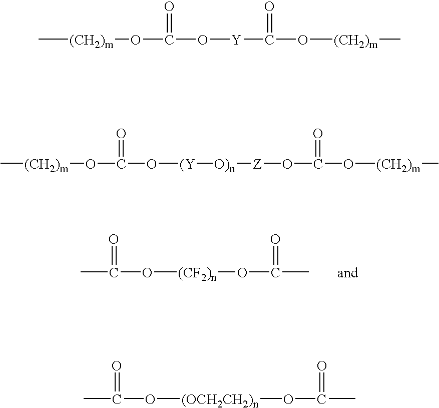

wherein Y and Z are each independently selected from C2 to C10 alkylene, m is an integer from 1 to 10, and n is an integer from 1 to 10;

Exemplary aromatic maleimides useful in the invention include, but are not limited to:

phenyl maleimide (PMI)

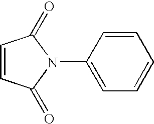

N-(2-CF₃-phenyl)maleimide (2CF3PMI)

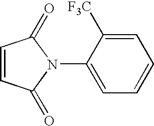

N-(2-t-butylphenyl)maleimide (NtBPMI)

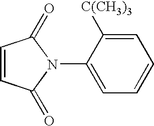

N-(2-CF₃-phenyl)methylmaleimide (2CF3PCI)

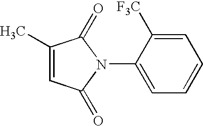

N-(2,4,6-isopropyl-3-maloimide phenyl)maleimide

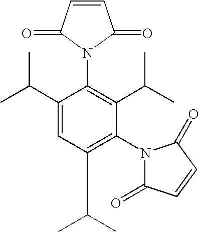

N-(2-iodophenyl)maleimide

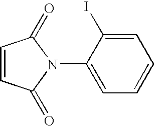

N-(2-bromo-3,5-CF₃-phenyl)maleimide

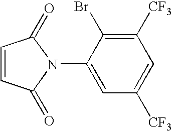

di(4-maleimidophenyl)methane

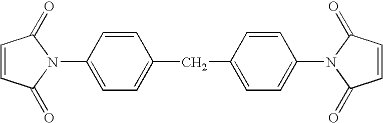

N-(2-chlorophenyl)maleimide

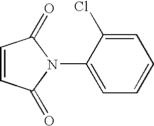

N-(2-bromophenyl)maleimide

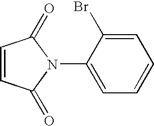

N-(2-fluorophenyl)maleimide

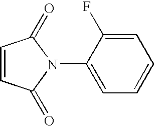

N-(4-CF₃-phenyl)maleimide

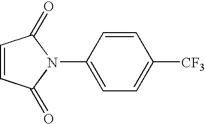

di(3,5-diethyl-4-maleimidophenyl)methane

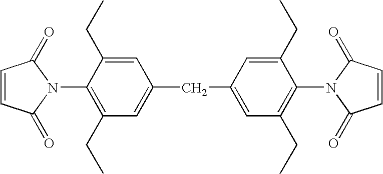

and the like.

Generally, aromatic maleimides can be prepared using techniques known in the art, with slight modifications as noted herein. The compounds, for example, can be synthesized using a two step method, which begins with the reaction of a suitably substituted aromatic amine with maleic anhydride (or a substituted maleic anhydride, such as citraconic anhydride) in a polar solvent, such as diethylether, to produce the amic acid in near quantitative yields. The amic acid is then recovered from the solvent and residual solvent and water can be removed from the recovered product.

The second step is acid catalyzed ring closure to form the imide. This reaction is performed by dissolving the amic acid in a suitable solvent, such as an organic hydrocarbon solvent such as toluene, optionally with a small amount of cosolvent, such as dimethylsulfoxide (DMSO), adding a catalytic amount of concentrated sulfuric acid, heating the mixture, preferably to reflux, and removing water through the water/solvent azeotrope. Excess solvent can then be removed, and the residual concentrated solution of the imide in solvent precipitated. The imide is then collected and dried to remove water and residual solvent(s). The second step can also give near quantitative yields. Aromatic maleimides useful in the invention are described, for example, in pending provisional application Serial No. 60/047,729, filed May 27, 1997, titled “Aromatic Maleimides,” and its corresponding published international application PCT Publication No. WO 98/54134, the entire disclosure of each of which is hereby incorporated by reference.

Further details concerning aromatic maleimide compounds including methods for their synthesis may be found in U.S. Pat. Nos. 6,150,431 and 6,153,662, the disclosures pertaining to such subject matter being incorporated herein by reference as if fully set forth herein.

As used herein, the term alkyl refers to linear or branched C1 to C10 alkyl, such as but not limited to methyl, ethyl, propyl, butyl, isopropyl, and the like, optionally substituted with halogen, aryl, arylalkyl, alkylaryl, cycloalkyl, alkoxy, heteroatoms, silicon derivatives, and the like. The term alkoxy refers to linear or branched C₁ to C₁₀ alkoxy. The term cycloalkyl refers to C₃ to C₆ cycloalkyl, such as but not limited to cyclopentyl and cyclohexyl, also optionally substituted with halogen, aryl, alkyl, arylalkyl, alkylaryl, alkoxy, heteroatoms, silicon derivatives and the like. The term aryl refers to C₃ to C₁₀ cyclic aromatic groups such as but not limited to phenyl, naphthyl, and the like, optionally substituted with halogen, alkyl, arylalkyl, alkylaryl, cycloalkyl, alkoxy, heteroatoms, silicon derivatives, and the like. The term heteroatom refers to oxygen, sulfur, and nitrogen.

Proportions

The proportions of the components in the coinitiator compositions of this invention can vary. In cases where a separate hydrogen atom or electron donor compound is used as a component, typically the ratio on a weight basis will fall in the range of about 0.01 to about 5 parts by weight of the donor compound(s) and in the range of about 0.05 to about 3 parts by weight of maleic imide or anhydride compound(s) per part by weight of coumarin(s). Preferred proportions are in the range of about 0.1 to about 5 parts by weight of the donor compound(s) and in the range of about 0.05 to about 1 part by weight of maleic imide or anhydride compound(s) per part by weight of coumarin(s).

When using a coumarin that requires no separate hydrogen atom or electron donor compound, typically the ratio will fall in the range of about 1.0 to about 5.0 pairs by weight of the maleic imide or anhydride compound(s) per pair by weight of coumarin(s). Preferred proportions fall in the range of about 0.1 to about 1.0 parts by weight of maleic imide or anhydride compound(s) per part by weight of coumarin(s). One or more hydrogen atom or electron donor compounds can, of course, also be used with a type d) coumarin, if desired.

The total amount of the above components mixed with the substrate monomer or oligomer to be photopolymerized can also be varied as long as there is a sufficient amount present to effect the polymerization under the selected polymerization conditions. Typically the total amount of the above components, proportioned as above, will be in the range of about 1 to about 5 wt %, and preferably in the range of about 1 to about 4 wt %, based on the weight of the monomer and/or oligomer and coinitiator of this invention. Selections within these ranges are typically made to suit the particular application method to be used. More preferred photopolymerizable compositions, especially those adapted for use in forming low viscosity web coatings, contain in the range of about 1 to about 4 wt % of one or more such monomers, based on the weight of the monomer and/or oligomer and coinitiator composition to be subjected to photopolymerization.

Departures from the foregoing ranges of proportions and amounts are permissible whenever deemed necessary or desirable, and are within the scope of this invention.

Photopolymerizable Monomers and Oligomers

The coinitiator systems of this invention can be used in the photopolymerization of a wide variety of monomers or oligomers containing at least one polymerizable carbon-to-carbon double bond. Typically the photopolymerizable monomer or oligomer and the coinitiator system are coated in a mixture, which as used herein includes physical mixtures as well as solutions, dispersions, and the like. Mixtures of two or more copolymerizable monomers, mixtures of two or more copolymerizable or crosslinkable oligomers, or mixtures of one or more copolymerizable monomers and one or more oligomers can be used, if desired

Many of these materials are photopolymerizable or photohardenable. These terms “photopolymerizable” and “photohardenable” refer to systems in which the molecular weight of at least one component of the photosensitive layer is increased by exposure to actinic radiation sufficiently to result in a change in the solubility or the rheological and thermal behavior of the exposed areas.

In high-speed photopolymerization of monomer or oligomer, films having a thickness of about 2 mils or less, such as in the manufacture of thinly-coated papers or thin high grade card or paperboard stock for use in magazine covers, brochures, corporate annual reports, folders, and the like in coating systems operating at high linear speeds, exposure times are extremely short. Such thin photopolymerizable monomer or oligomer coating films are typically applied to paper webs travelling at speeds of about 10 feet per second and thus the photopolymerization exposure time of such coated webs travelling at such speeds can be in the range of as little as about 0.005 to 0.02 second. Thus the coinitiator system of this invention selected for such use is one that functions extremely rapidly while at the same time becoming fixed within the polymerized coating without unacceptable discoloration and without undergoing or causing other types of degradation within the thin film.

The photopolymerizable layer may be composed of a polymerizable monomer and a polymerizable polymer in a mixture with the coinitiator system. Where a photopolymerizable molecule has more than one reactive site, a cross-linked network can be produced.

An advantageous feature of such concurrent high-speed production and in situ application or bonding of such thin photopolymerized coatings on a travelling paper or thin paperboard or card stock is that no other operations such as washing or drying are required. Indeed, it is preferable to conduct the concurrent production and in situ application or bonding of not only such thin photopolymerized coatings on a travelling paper or thin paperboard or card stock, but also the production of other articles, coatings, or laminates without use of washing or drying steps. In short the finished articles of this invention are produced with a minimum of steps. All that is required is to place the photopolymerizable composition in the proper place and configuration to be photopolymerized and expose the resultant article to sufficient radiation to effect the in situ photopolymerization. Printed matter, decorations, or the like may thereafter be applied to the photopolymerized article, coating, or laminate using conventional techniques, if desired.

The photopolymerized compositions of this invention can themselves constitute photopolymerizable inks or coatings applied as printed, decorative, or pictorial matter on a substrate and then photopolymerized in place. In this embodiment of the invention the photopolymerizable composition will include one or more pigments, dyes, or other color-producing substances so that permanent printed matter is formed upon exposure of the resultant article to radiation to effect photopolymerization.

Preferred photopolymerizable monomers for use in the practice of this invention include acrylic monomers, such as acrylic and methacrylic acids, and their amides, esters, salts, and corresponding nitriles. Non-limiting examples of such acrylate and methacrylate monomers and oligomers include methyl acrylate, methyl methacrylate, ethyl acrylate, ethyl methacrylate, n-butyl acrylate, n-butyl methacrylate, isbutylmethacrylate, isooctylacrylate, 2-ethylhexyl acrylate, 2-ethylhexyl methacrylate, lauryl acrylate, lauryl methacrylate, cyclohexyl acrylate, cyclohexyl methacrylate, isobornyl acrylate, isobornyl methacrylate, hydroxyethyl acrylate, hydroxyethyl methacrylate, hydroxypropylacrylate, hydroxy-2-ethylhexylmethacrylate, dimethylaminopropyl acrylate, dimethylaminopropyl methacrylate, diethylaminopropyl acrylate, diethylaminopropyl methacrylate, allyl acrylates such as allylacrylate, and allylmethacrylate, glycidylmethacrylate, aminoplast acrylates such as melamine acrylate, and the like, as well as mixtures of any two or more thereof.

Polyfunctional monomers and oligomers, i.e., compounds or oligomers having more than one alpha-beta-ethylenic site of unsaturation, can also be used in the practice of this invention. Non-limiting examples of such substances include ethylene glycol diacrylate, ethylene glycol dimethacrylate, 1,4-butanediol diacrylate, 1,4-butanediol dimethacrylate, 1,6-hexanediol diacrylate, 1,6-hexanediol dimethacrylate, diethylene glycol diacrylate, diethylene glycol dimethacrylate, dipropylene glycol diacrylate, dipropylene glycol dimethacrylate, tripropylene glycol diacrylate, tripropylene glycol dimethacrylate, trimethylolpropane triacrylate, trimethylolpropane trimethacrylate, glycerol diacrylate, glycerol dimethacrylate, aliphatic urethane diacrylate, aliphatic urethane dimethacrylate, aliphatic urethane triacrylate, aliphatic urethane hexaacrylate, aromatic urethane diacrylate, aromatic urethane dimethacrylate, aromatic urethane triacrylate, polyethylene glycol (400) diacrylate, polyethylene glycol (400) dimethacrylate, polyethylene glycol (600) diacrylate, polyethylene glycol (600) dimethacrylate, ethoxylated neopentylglycol diacrylate, ethoxylated neopentylglycol dimethacrylate, propoxylated neopentyl glycol diacrylate, propoxylated neopentyl glycol dimethacrylate, highly ethoxylated trimethylolpropane triacrylate, highly ethoxylated trimethylolpropane trimethacrylate, ethoxylated bisphenol A diacrylate, ethoxylated bisphenol A dimethacrylate, erythritol tetraacrylate, erythritol tetramethacrylate, amino-modified epoxy diacrylate, epoxy novolac triacrylate, divinylbenzene, 1,3-diisopropenylbenzene, polyester triacrylate, polyester tetraacrylate, polyester hexaacrylate, and diluted acrylic acrylate oligomers such as Ebecryl® 740-40TP, Ebecryl® 745, Ebecryl® 754, Ebecryl® 1701, Ebecryl® 1701-TP20, and Ebecryl® 1710 (all from UCB Chemicals Corporation), and the like, as well as mixtures of any two or more thereof. Other suitable acrylates include silicon-urethane acrylates or methacrylates. Preferred photopolymerizable monomers for use in the practice of this invention include tripropylene glycol diacrylate, trimethylol propane tetraacrylate, ethoxylated trimethylol propane tetraacrylate, propoxylated neopentyl glycol diacrylate, 1,6-hexanediol diacrylate, and the like, as well as mixtures of any two or more thereof.

In general, the preferred photopolymerizable compounds containing olefinic unsaturation are one or more photopolymerizable acrylate or methacrylate compositions. By “photopolymerizable acrylate or methacrylate composition” or “photopolymerizable acrylate derivative” is meant any composition whether in monomeric, dimeric, trimeric, or higher oligomeric form that contains photopolymerizable acrylic or methacrylic functionality in the composition, some non-limiting examples of which are set forth in the preceding two paragraphs.

If desired, alpha,beta-ethylenically unsaturated carboxylic acids can be used in conjunction with acrylate and/or methacrylate monomers, typically for the purpose of providing improved adhesion to certain substrates. Examples of such acids include methacrylic acid, acrylic acid, itaconic acid, maleic acid, beta-carboxyethyl acrylate, beta-carboxyethyl methacrylate, and the like, as well as mixtures of any two or more thereof. Preferred composition of this invention are, however, devoid of such carboxylic acids except as may be present as impurities or as residuals from manufacture.

Other suitable photopolymerizable monomers that can be used in the practice of this invention include vinyl acetate, vinyl and vinylidene halides and amides, i.e., methacrylamide, acrylamide, diacetone acrylamide, vinyl and vinylidene esters, vinyl and vinylidene ethers, vinyl and vinylidene ketones, butadiene, vinyl aromatics, i.e., styrene, alkyl styrenes, halostyrenes, alkoxystyrenes, divinyl benzenes, vinyl toluene, and the like are also included. Prepolymers including acrylated epoxides, polyesters and polyurethanes can be combined with a suitable monomer for viscosity control. The photopolymerizable compounds may be polymerized to form homopolymers or copolymerized with various other monomers.

The photopolymerizable compound can be present in the compositions of this invention in amounts from about 0 to about 99.8, preferably about 80 to about 99.8, percent by weight, based on the total weight of the composition.

The photopolymerizable compositions can be applied or deposited on a surface of a substrate using conventional techniques and apparatus. The composition can be applied as a substantially continuous film. Alternatively, the composition can be applied in a discontinuous pattern. The thickness of the deposited composition can vary, depending upon the desired thickness of the resultant cured product.

Typically, the substrate is coated with the uncured photopolymerizable composition and passed under a commercially available UV or excimer lamp on a conveyer moving at predetermined speeds. The substrate to be coated can be, for example, metal, wood, mineral, glass, paper, plastic, fabric, ceramic, and the like.

The active energy beams used in accordance with the present invention may be visible light or ultraviolet light or may contain in their spectra both visible and ultraviolet light. The polymerization may be activated by irradiating the composition with ultraviolet light using any of the techniques known in the art for providing ultraviolet radiation, i.e., in the range of 200 nm and 450 nm ultraviolet radiation. The radiation may be natural or artificial, monochromatic or polychromatic, incoherent or coherent and should be sufficiently intense to activate the photoinitiators of the invention and thus the polymerization. Conventional radiation sources include fluorescent lamps, excimer lamps, mercury, metal additive and arc lamps. Coherent light sources are the pulsed nitrogen, xenon, argon ion- and ionized neon lasers whose emissions fall within or overlap the ultraviolet or visible absorption bands of the compounds of the invention.

The compositions are useful in any of the types of applications known in the art for photopolymerizations, including as a binder for solids to yield a cured product in the nature of a paint, varnish, enamel, lacquer, stain or ink. The compositions are particularly useful in the production of photopolymerizable surface coatings in printing processes, such as lithographic printing, screen printing, and the like.

The present invention will be further illustrated by the following non-limiting examples in which all percentages are by weight.

Photo-DSC (differential scanning calorimetry) was performed using a Perkin-Elmer DSC-7 modified with the addition of quartz windows in the sample head cover and a 450-W medium-pressure mercury lamp. Light intensities of the full arc were approximately 50 mW cm⁻², with lower light intensities attained by using neutral density filters or changing the distance between the lamp and the sample cells. Specific spectral bands were isolated with the use of band-pass filters at 365 nm and 436 nm. The sample cell chamber was purged with N₂ at 25° C. for 2.5 mm prior to polymerization. Data was acquired using the supplied Pyris software from Perkin-Elmer and further manipulation of the exported ASCII data format was performed using an Origin 6.0 spreadsheet and plotting software. The photo-DSC runs were performed using aluminum sample pans from Perkin-Elmer. These pans were specially crimped to have an indention in the bottom of the pan in order to keep liquid samples from migrating to the sides of the pan and rising due to capillary forces. All samples were approximately 2 μL and were introduced onto the aluminum DSC pans using a microliter syringe. The samples pans were cleaned prior to use by repeated boiling in methylene chloride or acetone to remove residual processing lubricants.

Line cure experiments were conducted on a Fusion UV Systems DRS-120 conveyer belt system with an intensity of 495 mJ per square centimeter from a Fusion D-bulb at 52 feet per minute. Samples were applied via a draw-down bar with a thickness of 7 wet mils on Q-Panels of cold rolled steel or Leneta charts. Samples were then passed under the UV light on the conveyer, and the extent of cure was determined by a thumb twist test.

1,6-Hexanedioldiacrylate and polyethylene glycol diacrylate were obtained from UCB Chemicals Corporation. N-Methylmaleimide, 2,3-dimethyl maleic anhydride, N-methyl-N,N-diethanolamine, 3,3′-carbonylbis(7-diethylaminocoumarin), anthraquinone, 1,2-naphthoquinone, benzanthrone, fluorenone, coumarin 6, coumarin 152, acridine orange, thionine, methylene blue, naphthol, phenazine, acridine and were all purchased from Aldrich Chemical Company. 5,7-Dimethoxy-3-(1-naphthoyl)coumarin and 3,3′-carbonylbis-(7-methoxycoumarin) were obtained from Eastman Chemical Company. N-(3,4-dicyanophenyl)phthalimide was synthesized as detailed in the literature.

### EXAMPLE 1

Using the procedure described above, photoinitiated polymerization of 1,6-hexanedioldiacrylate (HDDA) initiated by a coumarin/amine/malemide system of this invention was carried out. This was performed via photo-DSC and the sensitizer absorbance was normalized to equal that of 1.0% of 2,2-dimethoxy-2-phenylacetophenone, a well known efficient cleavage initiator. The compositions tested were:

a) HDDA with 1.0% of 2,2-dimethoxy-2-phenylacetophenone (DMPA) at 365 nm,

b) HDDA with 0.01% of 3,3′-carbonylbis(7-methoxycoumarin) (CBC), 1.0% of N-methyldiethanolamine (MDEA), and 0.1% of N-methylmaleimide (MMI);

c) HDDA with 0.01% of CBC and 1.0% of MDEA.

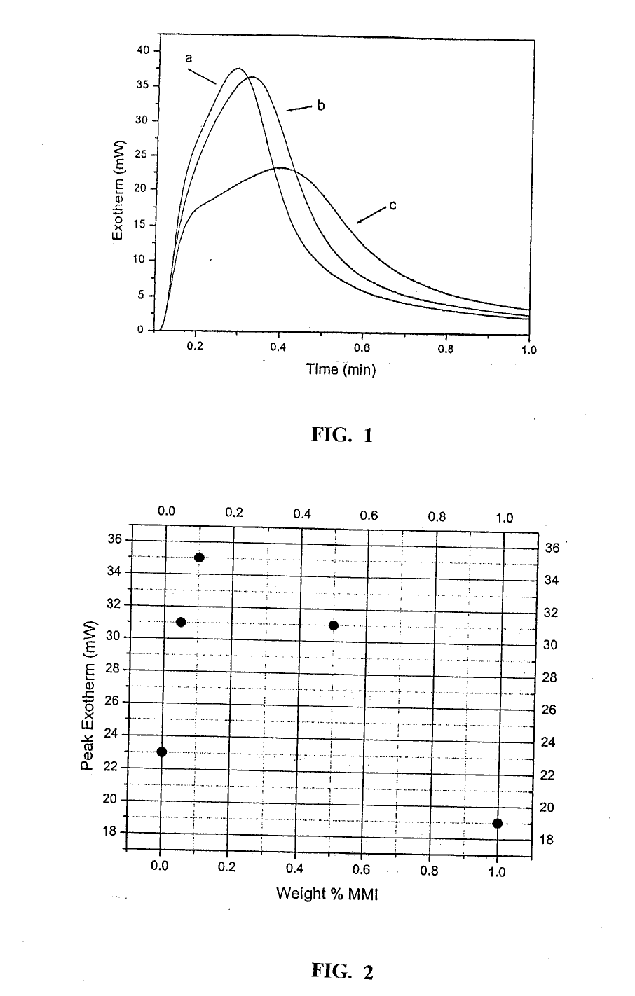

Light intensity was 0.11 mW/cm² at 365 nm in nitrogen. The exotherms produced by compositions a), b), and c) are presented graphically in FIG. 1. It can be seen that composition b) of this invention gave a marked increase in the rate of polymerization as compared to the composition of c). In fact, the rate was comparable to the rate given by DMPA which, although an efficient cleavage initiator, has a tendency over time of producing strong yellow coloration and development of odors in the polymer.

### EXAMPLE 2

A series of photo-DSC peak exotherms were generated with HDDA initiated by CBC/MDEA/MMI compositions of this invention. The sensitizer 3,3′-carbonylbis(7-methoxycoumarin) (CBC) concentration was 0.01% with 1% of MDEA. The percentages of MMI were varied from 0 up to 1%. Light intensity was 0.11 mW/cm² at 365 nm in nitrogen. The peak exotherms are shown in FIG. 2. It can be seen that in this system the optimum concentration of MMI is approximately 0.1%.

### EXAMPLE 3

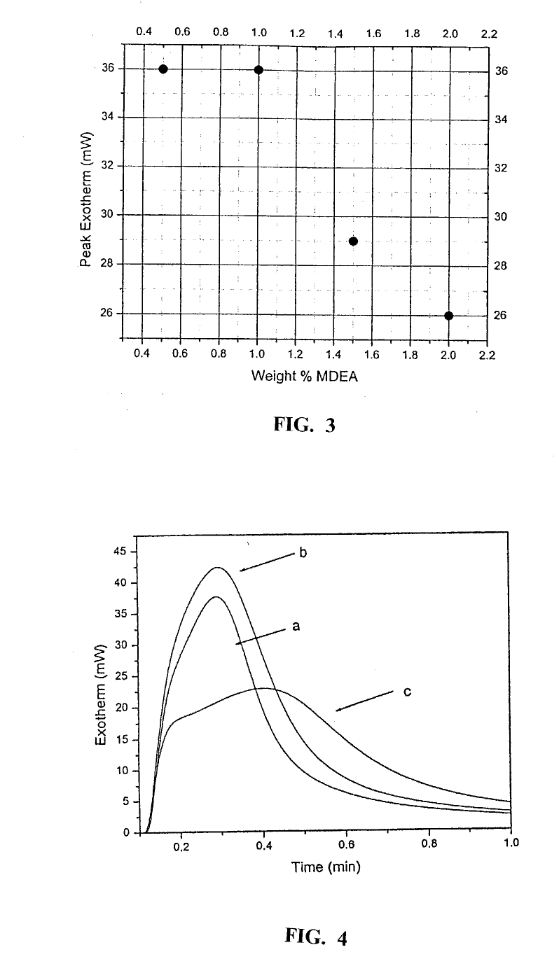

A series of photo-DSC peak exotherms were generated with HDDA initiated by CBC/MDEA/MMI compositions of this invention. The sensitizer 3,3′-carbonylbis(7-methoxycoumarin) (CBC) concentration was 0.01% with 0.1% of MMI. The percentages of MDEA were varied from 0.5 up to 2%. Light intensity was 0.11 mW/cm² at 365 nm in nitrogen. The peak exotherms are shown in FIG. 3. It can be seen that in this system the optimum concentration of MDEA is in the range of about 0.5% to about 1%.

### EXAMPLE 4

The procedure as in Example 1 was repeated except that the coumarin used was 5,7-dimethoxy-3-(1-naphthoyl)coumarin and its concentration was 0.08%. Thus the compositions tested were as follows:

a) HDDA with 1.0% of 2,2-dimethoxy-2-phenylacetophenone (DMPA) at 365 nm;

b) HDDA with 0.08% of 5,7-dimethoxy-3-(1-naphthoyl)coumarin (DMC), 1.0% of N-methyldiethanolamine (MDEA), and 0.1% of N-methylmaleimide (MMI);

c) HDDA with 0.08% of DMC and 1.0% of MDEA.

The results of these experiments are depicted graphically in FIG. 4. The results show that composition b) of this invention gave a marked increase in the rate of polymerization as compared to the composition of c). In fact, the rate was comparable to the rate given by DMPA and the shortcomings of DMPA noted above would be avoided.

### EXAMPLE 5

A series of photo-DSC peak exotherms were generated with HDDA initiated by DMC/MDEA/MMI compositions of this invention. The sensitizer 5,7-dimethoxy-3-(1-naphthoyl)coumarin (DMC) concentration was 0.08% with 1% of MDEA. The weight percentages of MMI were varied from 0 up to 1%. Light intensity was 0.11 mW/cm² at 365 nm in nitrogen. The peak exotherms are shown in FIG. 5. It can be seen that in this system the optimum concentration of MMI is in the range of approximately 0.05% to 0.5%.

### EXAMPLE 6

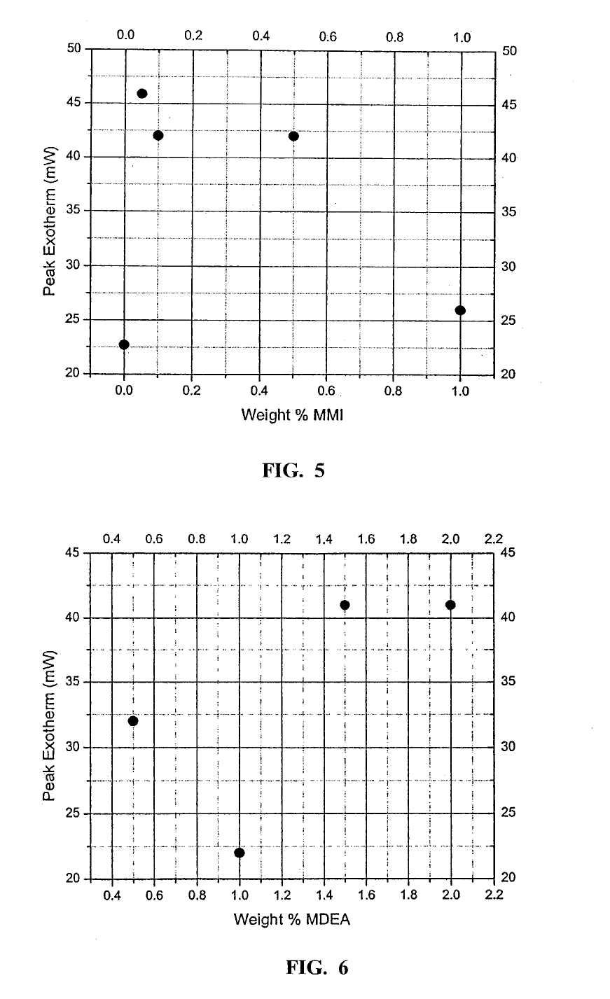

A series of photo-DSC peak exotherms were generated with HDDA initiated by DMC/MDEA/MMI compositions of this invention. The sensitizer 5,7-dimethoxy-3-(1-naphthoyl)coumarin (DMC) concentration was 0.08% with 0.1% of MMI. The percentages of MDEA were varied from 0.5 up to 2%. Light intensity was 0.11 mW/cm² at 365 nm in nitrogen. The peak exotherms are shown in FIG. 6. It can be seen that in this system the optimum concentration of MDEA is in the range of about 1.5% to about 2%.

### EXAMPLE 7

The procedure as in Example 1 was repeated except that the coumarin used was 3,3′-carbonylbis(7-diethylaminocoumarin) (CBD) and its concentration was 0.08%. Thus the compositions tested were as follows:

a) HDDA with 1.0% of 2,2-dimethoxy-2-phenylacetophenone (DMPA) at 365 nm;

b) HDDA with 0.01% of 3,3′-carbonylbis(7-diethylaminocoumarin) (CBD), 1.0% of N-methyldiethanolamine (MDEA), and 0.05% of N-methylmaleimide (MMI),

c) HDDA with 0.01% of CBD and 1.0% of MDEA.

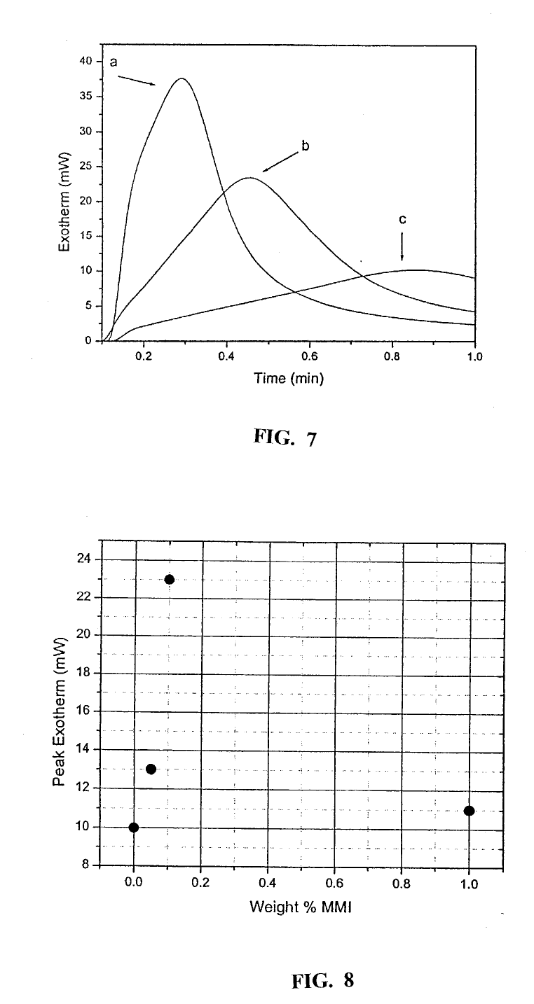

The results of these experiments are depicted graphically in FIG. 7. The results show that composition b) of this invention gave a marked increase in the rate of polymerization as compared to the composition of c). Also, the shortcomings of DMPA noted above were avoided.

### EXAMPLE 8

A series of photo-DSC peak exotherms were generated with HDDA initiated by CBD/MDEA/MMI compositions of this invention. The sensitizer 3,3′-carbonylbis(7-diethylaminocoumarin) (CBD) concentration was 0.08% with 1% of MDEA. The weight percentages of MMI were varied from 0 up to 1%. Light intensity was 0.11 mW/cm² at 365 nm in nitrogen. The peak exotherms are shown in FIG. 8. It can be seen that in this system the optimum concentration of MMI appears to be approximately 0.1%.

### EXAMPLE 9

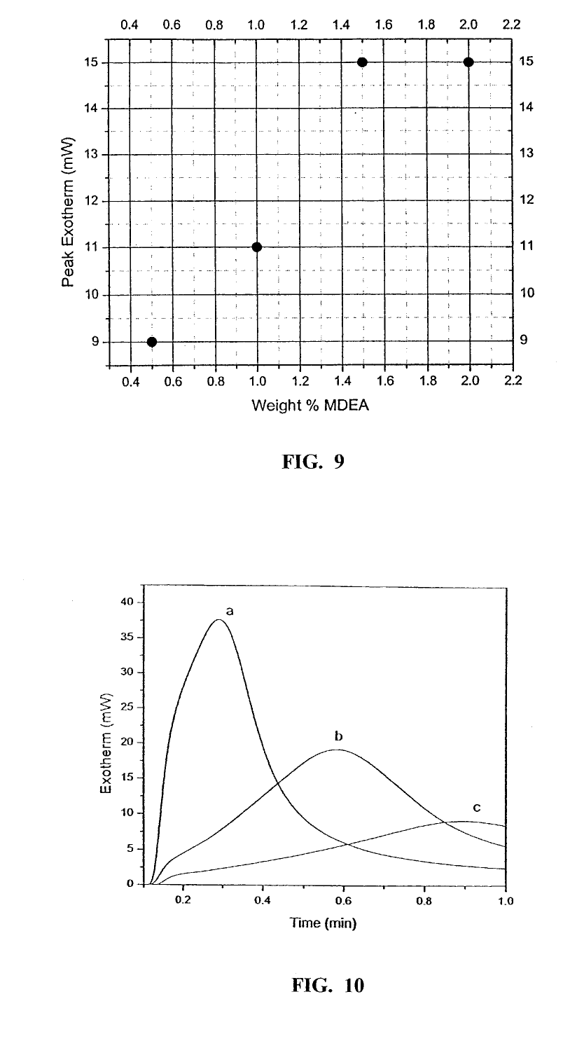

A series of photo-DSC peak exotherms were generated with HDDA initiated by CBC/MDEA/MMI compositions of this invention. The sensitizer 3,3′-carbonylbis(7-diethylaminocoumarin) (CBD) concentration was 0.08% with 0.1% of MMI. The percentages of MDEA were varied from 0.5 up to 2%. Light intensity was 0.11 mW/cm² at 365 nm in nitrogen. The peak exotherms are shown in FIG. 9. It can be seen that in this system the optimum concentration of MDEA is in the range of about 1.5% to about 2%.

### EXAMPLE 10

The procedure as in Example 1 was repeated except that the coumarin used was 3,3′-carbonylbis(7-diethylaminocoumarin) (CBD), its concentration was 0.01%, and light intensity was 0.10 mW/cm² at 436 nm in nitrogen for the compositions containing the CBD. Since DMPA cannot be used at 436 nm, the light intensity for the standard run a) was 0.11 mW/cm² at 365 nm in nitrogen. The compositions tested were as follows:

a) HDDA with 1.0% of 2,2-dimethoxy-2-phenylacetophenone (DMPA) at 365 nm;

b) HDDA with 0.01% of 3,3′-carbonylbis(7-diethylaminocoumarin) (CBD), 1.0% of N-methyldiethanolamine (MDEA), and 0.1% of N-methylmaleimide (MMI) at 436 nm;

c) HDDA with 0.01% of CBD and 1.0% of MDEA at 436 nm.

The results of these experiments are depicted graphically in FIG. 10. The results show that composition b) of this invention gave an increase in the rate of polymerization as compared to the composition of c). Also, the shortcomings of DMPA noted above were avoided.

### EXAMPLE 11

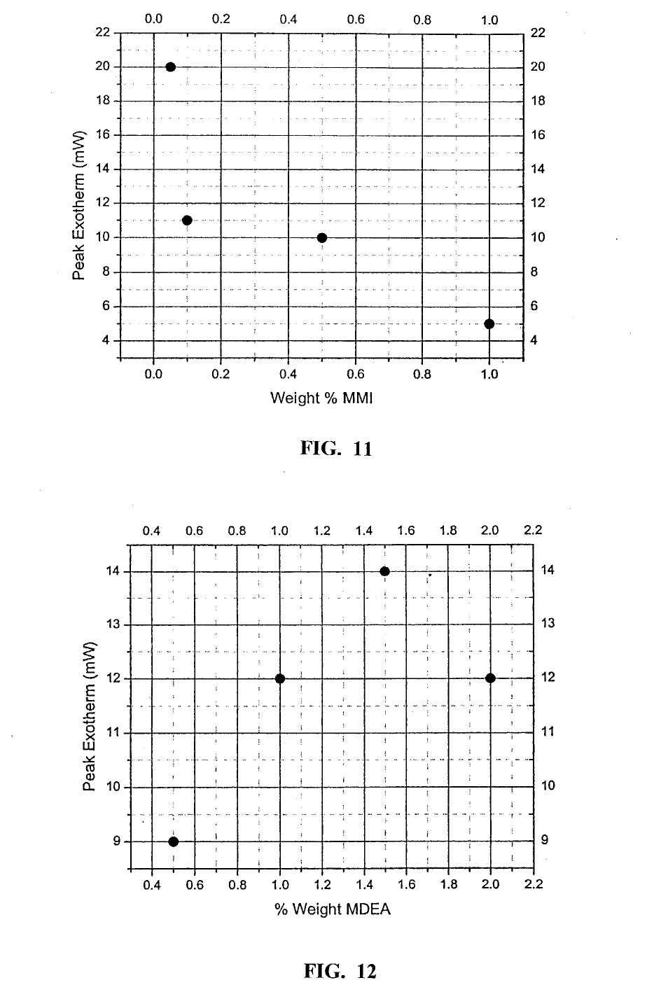

A series of photo-DSC peak exotherms were generated with HDDA initiated by CBD/MDEA/MMI compositions of this invention. The sensitizer 3,3′-carbonylbis(7-diethylaminocoumarin) (CBD) concentration was 0.01% with 1% of MDEA. The percentages of MMI were varied from 0 up to 1%. Light intensity was 0.10 mW/cm² at 436 nm in nitrogen. The peak exotherms are shown in FIG. 11. It can be seen that in this system the optimum concentration of MMI appears to be approximately 0.05%.

### EXAMPLE 12

A series of photo-DSC peak exotherms were generated with HDDA initiated by CBC/MDEA/MMI compositions of this invention. The sensitizer 3,3′-carbonylbis(7-diethylaminocoumarin) (CBD) concentration was 0.01% with 0.1% of MMI. The percentages of MDEA were varied from 0.5 up to 2%. Light intensity was 0.10 mW/cm² at 436 nm in nitrogen. The peak exotherms are shown in FIG. 12. It can be seen that in this system the optimum concentration of MDEA was approximately 1.5%.

In various other experiments similar to those reported in Examples 1, 4, 7, or 10 above, it was found that [3-(2-benzothiazolyl)-7-(diethylamino)coumarin] and [7-(dimethylamino)-4-(trifluoromethyl)coumarin] did not initiate any appreciable polymerization of HDDA in the presence or absence of MMI. No reason is known for this anomalous behavior. It was also found that 2,3-dimethylmaleic anhydride when used with CBC and MDEA gave a slight increase for HDDA polymerization at full arc of the mercury lamp and also at 436 nm as compared to HDDA with CBC and MDEA under the same conditions.

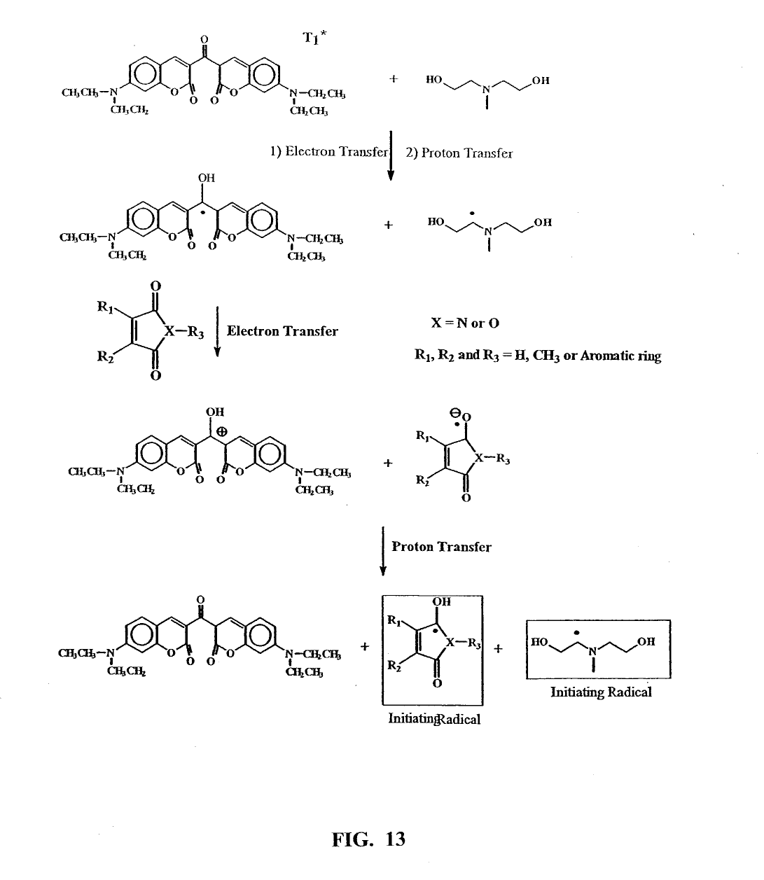

The precise mechanism by which the photoinitiator compositions of this invention function is not known, and this invention is not intended to be limited by any mechanism or theory of operation. One postulated mechanism which is deemed reasonable is depicted in FIG. 13. It will be seen that this postulated mechanism results in the formation of two different initiating radicals for enhancing the photopolymerization.

As used herein, and as will be appreciated by the skilled artisan, the term photopolymerizable composition refers to compositions which harden or cure upon exposure to radiation.

Generally the polymerizable compositions of the invention include ethylenically unsaturated compounds, including monomers and oligomers derived from acrylic and methacrylic acid, optionally dispersed or dissolved in a suitable solvent that is copolymerizable therewith, and mixtures thereof, which are photopolymerizable when exposed to a source of radiation (ultraviolet or UV radiation, or radiation outside the UV spectrum), particularly for free radical polymerizable systems. As will be appreciated by the skilled artisan, the photopolymerizable compounds can be monofunctional, or can include two or more polymerizable ethylenically unsaturated groupings per molecule.

The photopolymerizable compositions of the invention may also contain other conventional agents, such as polymerization inhibitors, fillers, ultraviolet absorbers, organic peroxides, dyes, pigments, and the like.

The photopolymerizable compositions can be applied or deposited on a surface of a substrate using conventional techniques and apparatus. The composition can be applied as a substantially continuous film. Alternatively, the composition can be applied in a discontinuous pattern. The thickness of the deposited composition can vary, depending upon the desired thickness of the resultant cured product. Typically, the substrate is coated with the uncured photopolymerizable composition and passed under a commercially available UV or excimer lamp on a conveyer moving at predetermined speeds. The substrate to be coated can be, for example, metal, wood, mineral, glass, paper, plastic, fabric, ceramic, and the like.

The active energy beams used in accordance with the present invention may be visible light or ultraviolet light or may contain in their spectra both visible and ultraviolet light. The polymerization may be activated by irradiating the composition with the aforementioned energy beams using any of the techniques known in the art for providing radiation, i.e., in the range of 200 nm and 450 nm ultraviolet radiation, or by irradiating the composition with radiation outside of the ultraviolet spectrum. The radiation may be natural or artificial, monochromatic or polychromatic, incoherent or coherent and should be sufficiently intense to activate the photoinitiators of the invention and thus the polymerization. Conventional radiation sources include fluorescent lamps, excimer lamps, mercury, metal additive and arc lamps. Coherent light sources include pulsed nitrogen, xenon, argon ion- and ionized neon lasers whose emissions fall within or overlap the ultraviolet or visible absorption bands of the compounds of the invention.

The compositions are useful in any of the types of applications known in the art for photopolymerizations, including as a binder for solids to yield a cured product in the nature of a paint, varnish, enamel, lacquer, stain or ink. The compositions can also be useful in the production of photopolymerizable surface coatings in printing processes, such as lithographic printing, screen printing, and the like. The compositions can also be useful in applications in which the compositions are applied to articles which are to be exposed to the environment, such as signage. Radiation cured coatings produced using conventional photoinitiators typically degrade over time (as evidenced by yellowing, increasing brittleness, and the like), which degradation is exacerbated by direct exposure to sunlight. In contrast, radiation cured coatings prepared using the maleimide compounds can exhibit minimal degradation overtime, even when exposed to direct sunlight. The maleimides can also be water soluble.

It is to be understood that the ingredients referred to by chemical name or formula anywhere in the specification or claims hereof, whether referred to in the singular or plural, are identified as they exist prior to coming into contact with another substance referred to by chemical name or chemical type (e.g., another reactant, a solvent, a diluent, or etc.). It matters not what preliminary chemical changes, transformations and/or reactions, if any, take place in the resulting mixture or solution or reaction medium as such changes, transformations and/or reactions are the natural result of bringing the specified reactants and/or components together under the conditions called for pursuant to this disclosure. Thus the reactants and other materials are identified as ingredients to be brought together in connection with performing a desired chemical reaction or in forming a mixture to be used in conducting a desired reaction. Also, even though the claims hereinafter may refer to substances, components and/or ingredients in the present tense (“comprises”, “is”, etc.), the reference is to the substance or ingredient as it existed at the time just before it was first contacted, blended or mixed with one or more other substances or ingredients in accordance with the present disclosure. The fact that the substance or ingredient may have lost its original identity through a chemical reaction or transformation or complex formation or assumption of some other chemical form during the course of such contacting, blending or mixing operations, is thus wholly immaterial for an accurate understanding and appreciation of this disclosure and the claims thereof. Nor does reference to an ingredient by chemical name or formula exclude the possibility that during the desired reaction itself an ingredient becomes transformed to one or more transitory intermediates that actually enter into or otherwise participate in the reaction. In short, no representation is made or is to be inferred that the named ingredients must participate in the reaction while in their original chemical composition, structure or form.

Each and every patent or other publication or published document referred to in any portion of this specification is incorporated in toto into this disclosure by reference, as if fully set forth herein.

This invention is susceptible to considerable variation in its practice. Therefore the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

That which is claimed is:

1. A coinitiator composition for photopolymerization of one or more photopolymerizable compounds containing olefinic unsaturation, said composition comprising:
a) (i) a combination of at least one coumarin photoinitiator and at least one coinitiator compound which is a hydrogen atom donating coinitiator or an electron donating coinitiator, or (ii) at least one coumarin photoinitiator having in its molecular structure at least one photosensitizing amino group; and
b) at least one compound containing at least one maleimide or maleic anhydride derivative.

2. A coinitiator composition as in claim 1 wherein a) is a combination of at least one coumarin photoinitiator and at least one coinitiator compound which is a hydrogen atom donating coinitiator or an electron donating coinitiator, and wherein b) is at least one compound containing at least one maleimide moiety.

3. A coinitiator composition as in claim 2 wherein said at least one coumarin photoinitiator is at least one ketocoumarin photoinitiator.

4. A coinitiator composition as in claim 2 wherein said at least one coumarin photoinitiator is at least one ketocoumarin photoinitiator and wherein said at least one coinitiator compound is at least one amine, at least one thiol, at least one ether, or at least one alcohol.

5. A coinitiator composition as in claim 4 wherein said at least one coinitiator compound is at least one amine.

6. A coinitiator composition as in claim 5 wherein said at least one amine is at least one trihydrocarbylamine or at least one tertiary dialkanolamine.

7. A coinitiator composition as in any of claims 3-6 wherein said at least one ketocoumarin photoinitiator is at least one ketocoumarin of the formula: 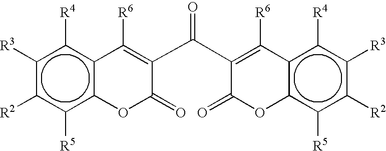
wherein each R² is alkoxy having 1 to 6 carbon atoms or dialkylamino with each alkyl containing 1 to 4 carbon atoms, and R³, R⁴, R⁵, and R⁶ are, independently, hydrogen atoms or alkyl groups each containing 1 to 6 carbon atoms and wherein at least two pairs of R³, R⁴, R⁵, and R⁶ are all hydrogen atoms.

8. A coinitiator composition as in claim 2 wherein a) is a combination of at least one 3,3′-carbonylbis(7-diloweralkylaminocoumarin) and at least one N-loweralkyl-N,N-dialkanolamine, and wherein b) is at least one N-loweralkylmaleimide.

9. A photopolymerizable composition which comprises:
A) at least one photopolymerizable compound containing olefinic unsaturation;
B) (i) a combination of at least one coumarin photoinitiator and at least one coinitiator compound which is a hydrogen atom donating coinitiator or an electron donating coinitiator, or (ii) at least one coumarin photoinitiator having in its molecular structure at least one photosensitizing amino group; and
C) at least one compound containing at least one maleimide or maleic anhydride moiety.

10. A photopolymerizable composition as in claim 9 wherein B) is a combination of at least one coumarin photoinitiator and at least one coinitiator compound which is a hydrogen atom donating coinitiator or an electron donating coinitiator, and wherein C) is at least one compound containing at least one maleimide moiety.

11. A photopolymerizable composition as in claim 10 wherein said at least one coumarin photoinitiator is at least one ketocoumarin photoinitiator.

12. A photopolymerizable composition as in claim 10 wherein said at least one coumarin photoinitiator is at least one ketocoumarin photoinitiator and wherein said at least one coinitiator compound is at least one amine, at least one thiol, at least one ether, or at least one alcohol.

13. A photopolymerizable composition as in claim 12 wherein said at least one coinitiator compound is at least one amine.

14. A photopolymerizable composition as in claim 13 wherein said at least one amine is at least one trihydrocarbylamine or at least one tertiary dialkanolamine.

15. A photopolymerizable composition as in any of claims 11-14 wherein said at least one ketocoumarin photoinitiator is at least one ketocoumarin of the formula: 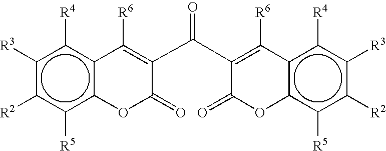
wherein each R² is alkoxy having 1 to 6 carbon atoms or dialkylamino with each alkyl containing 1 to 4 carbon atoms, and R³, R⁴, R⁵, and R⁶ are, independently, hydrogen atoms or alkyl groups each containing 1 to 6 carbon atoms and wherein at least two pairs of R³, R⁴, R⁵, and R⁶ are all hydrogen atoms

16. A photopolymerizable composition as claim 10 wherein A) is a photopolymerizable acrylate or methacrylate composition, B) is a combination of at least one 3,3′-carbonylbis(7-diloweralkylaminocoumarin) and at least one N-loweralkyl-N,N-dialkanolamine, and wherein C) is at least one N-loweralkylmaleimide.

17. A process which comprises photopolymerizing at least one polymerizable compound containing olefinic unsaturation by exposing said at least one polymerizable compound to radiation in the presence of a polymerization coinitiator composition comprised of:
a) (i) a combination of at least one coumarin photoinitiator and at least one coinitiator compound which is a hydrogen atom donating coinitiator or an electron donating coinitiator, or (ii) at least one coumarin photoinitiator having in its molecular structure at least one photosensitizing amino group; and
b) at least one compound containing at least one maleimide or maleic anhydride moiety.

18. A process as in claim 17 wherein a) is a combination of at least one coumarin photoinitiator and at least one coinitiator compound which is a hydrogen atom donating coinitiator or an electron donating coinitiator, and wherein b) is at least one compound containing at least one maleimide moiety.

19. A process as in claim 18 wherein said at least one coumarin photoinitiator is at least one ketocoumarin photoinitiator.

20. A process as in claim 18 wherein said at least one coumarin photoinitiator is at least one ketocoumarin photoinitiator and wherein said at least one coinitiator compound is at least one amine, at least one thiol, at least one ether, or at least one alcohol.

21. A process as in claim 20 wherein said at least one coinitiator compound is at least one an amine.

22. A process as in claim 21 wherein said at least one amine is at least one trihydrocarbylamine or at least one tertiary dialkanolamine.

23. A process as in any of claims 19-22 wherein said at least one ketocoumarin photoinitiator is at least one ketocoumarin of the formula: 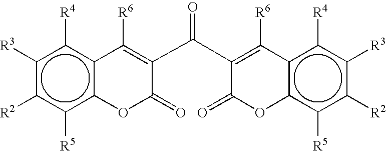
wherein each R² is alkoxy having 1 to 6 carbon atoms or dialkylamino with each alkyl containing 1 to 4 carbon atoms, and R³, R⁴, R⁵, and R⁶ are, independently, hydrogen atoms or alkyl groups each containing 1 to 6 carbon atoms and wherein at least two pairs of R³, R⁴, R⁵, and R⁶ are all hydrogen atoms

24. A process as in claim 23 wherein A) said at least one polymerizable compound is at least one acrylate derivative, wherein a) is a combination of at least one 3,3′-carbonylbis(7-diloweralkylaminocoumarin) and at least one N-loweralkyl-N,N-dialkanolamine, and wherein b) is at least one N-loweralkylmaleimide.

25. Paper, paperboard stock, or polymer film or sheeting having a photopolymerized coating, decoration, and/or printed matter comprised of a composition of any of claims 9-14 or 16.

26. Paper, paperboard stock, or polymer film or sheeting having a photopolymerized coating, decoration, and/or printed matter comprised of a composition of claim 15.
